(19) United States
(12) Patent Application Publication
(10) Pub. No.: US 2018/0273360 A1
(43) Pub. Date: Sep. 27, 2018

(54) AirJackX

(71) Applicant: Shaz Nasrin, Watchung, NJ (US)

(72) Inventor: Shaz Nasrin, Watchung, NJ (US)

(21) Appl. No.: 15/466,879

(22) Filed: Mar. 23, 2017

(51) Int. Cl. B66F 3/35

(52) U.S. Cl. CPC B66F 3/35

(57) ABSTRACT

The inflatable jack consists of an air jack, extension hose, built-in car compressor and an air tank. Optionally, impact lug nut gun and tire gauge can be provided with the system. The air jack consists of two parts, flexible rubber bag, base and top plates which are made out of solid plastic to keep the jack intact and free from getting damaged. The air compressor and air tank are attached to the car and it draws power from the car battery itself. The air jack is able to withstand the weight of the car and it does not move from its location due to the solid plastic plate with a top rubber surface. There will be a button on the dashboard which upon pressing will turn on the compressor, which in turn fills up the air tank and releases the air into the jack. The air drain valve available on the air jack will let it deflate flat and it can then be placed in the trunk.

### FIELD OF THE INVENTION

The present invention relates generally to an air compressor connected to a car operated vehicle jack, and in particular, to an air compressor operated vehicle jack having a flexible Inflate/Deflate construction.

### BACKGROUND OF THE INVENTION

It is quite common to get a flat tire. Mostly the remedy to change the flat tire is by accessing the underside of the vehicle or lifting the vehicle. Usually this is accomplished via a mechanical jack included in most vehicles.

Mechanical jacks involve the use of physical exertion through a lever or screw system to produce the power necessary to raise the vehicle to a suitable height. In case of heavy car or long journeys, the physical exertion required is beyond that which is capable by the operator, and thus the service of a tow truck is required to perform the necessary repairs or to tow the vehicle to somewhere where the proper equipment is available. This is also a common problem when there is a need to carry out any mechanical repairs underneath the vehicle.

Various attempts have been made to provide alternate methods for lifting a vehicle in order to perform repairs or change tires. Examples of these attempts can be seen by reference to several U.S. patents, including U.S. Pat. No. 2,495,092; U.S. Pat. No. 3,695,582; U.S. Pat. No. 3,565,398; U.S. Pat. No. 4,741,086; U.S. Pat. No. 6,082,708; U.S. Pat. No. 4,560,145; and U.S. Pat. No. 6,877,200.

However, none of these designs are similar to the present invention. While these apparatuses fulfil their respective, particular objectives, each of these references suffer from one or more disadvantages. It is very difficult to transport or move many of such apparatuses manually. Many of them require fairly complicated setup in order to use them and are not conveniently compactable for storage. Some of these apparatuses require power supplies. Many of these apparatuses are complicated or physically demanding to operate and adjust. Thus, there exists a need for a vehicle lifting apparatus which is compact in configuration and simple in operation. The development of the present invention substantially differs from the conventional solutions and provides greater benefits over the existing devices currently available.

### SUMMARY OF THE INVENTION

In view of the above references, the inventor recognized the inherent problems and observed that there is a need for a vehicle jack which is pneumatically and electrically-operated in a simple manner and adapted for simple transport and compact storage. Thus, the objective of the present invention is to solve the aforementioned disadvantages.

To achieve the above objectives, it is an objective of the present invention to provide a compact air compressor and air tank permanently installed in a vehicle. A vehicle jack for lifting vehicle for various repairs that can be utilized in a portable manner. The apparatus comprises of an air jack, air extension hose, built-in car compressor and tank.

Another objective of the present invention is to comprise the base and top portions of solid plastic, which provide support to the rubber air bag. The top part further comprises a rubberized surface which provides better grip to hold vehicle in place.

Yet still another objective of this invention is to lift the vehicle utilizing the rubber bag. The rubber bag is made up of flexible rubber attached to both the base and the top solid plastic portions. The rubber bag can be inflated with a volume of compressed air which is supplied by the built-in car compressor and built-in air tank.

Another objective of this invention is to provide the top portion of the jack with a flat rubberized surface to stabilize the vehicle and the jack during use. The rubberized surface provides a high-friction interface upon contact with a bottom surface of the vehicle.

The objective of the present invention is to provide simple actuation of the jack using a power switch available on the vehicle's dashboard that automatically inflates the bladder.

Another objective of the present invention comprises of a first port and second port providing pneumatic communication with a pressure relief valve and the compressor, respectively. The first port and second port enable deflation and inflation of the apparatus.

Another objective of the present invention comprises of an air hose between the air tank and the air jack. The hose is coiled and therefore has a slight tension. Once the air hose is detached from the air tank and air jack, it will recoil and take less storage space.

Another objective of the present invention is to provide built-in air compressor and air tank fitted in the vehicle which can be operated by a switch provided on the dashboard. The air-compressor is used to compress the air, while air tank is provided to store the compressed air in it.

The present invention is to provide a method of utilizing the device that provides a unique means of procuring the air jack, placing it under a vehicle, plugging the air hose into one of the built-in air hose connections on either side of the vehicle, initiating the air compressor to inflate the air tank and releasing air to the rubber bag by pressing the switch available on dashboard to “ON” position, filling the rubber bag to a desired height, the operator can then perform needed tasks while the vehicle is jacked off the ground surface. Lowering the air jack is done by opening the air valve and discharging the air out of the bag. This will deflate the bag allowing it to go back into its natural flat position with the operator able to remove and store the air jack. Utilizing the switch located on the dashboard, will allow the operator to benefit from reduced effort and increased safety afforded by the present invention.

Another objective of the present invention is to provide two buttons on the dashboard of the car. The first button will be used for jacking the car. The button “OFF” mode will be connected with tilt sensors which can detect the tilt of the car. When tire is lifted sufficiently above ground, the tilt sensor will enable “OFF” mode of button and jack will not be over pressurized. Another switch is for “air gun”. The air gun can be connected to same air hose as that of the air jack. Once the switch is activated, air gun can be used to take off the lug nuts of the wheel.

Further objectives and advantages of the present invention will become apparent from a consideration of the drawings and ensuing description.

### BRIEF DESCRIPTION OF THE DRAWINGS

FIG. 1 is a LEFT SIDE view and perspective view of the air jack depicting the inflated state of it, according to a preferred embodiment of the present invention;

FIG. 2 is a FRONT view and perspective view of the air jack depicting the inflated state of it, according to a preferred embodiment of the present invention;

FIG. 3 is a LEFT SIDE CORNER AND TOP view and perspective view of an air jack depicting an inflated state along with depiction of air inlet valve and pressure release valve, according to a preferred embodiment of the present invention;

FIG. 4 is a BOTTOM view and perspective view of the air jack depicting the inflated state of it, according to a preferred embodiment of the present invention;

FIG. 5 is a TOP view and perspective view of the air jack depicting the inflated state of it, according to a preferred embodiment of the present invention;

FIG. 6 is a BACK CORNER & TOP view and perspective view of the air jack depicting the inflated state of it, according to a preferred embodiment of the present invention;

FIG. 7 is a front view of a car with the Air Jack in its fully inflated state lifting the car off the ground

FIG. 8 similar to FIG. 1 is a LEFT SIDE view and perspective view of the air jack depicting the inflated state of it, according to a preferred embodiment of the present invention;

FIG. 9 is a REAR view of a car, with air jack depicting an inflated state along with depiction of air inlet valve and pressure release valve, This figure shows the location of the built in compressor, Air Tank, Air Hose connection to the Air Jack X according to a preferred embodiment of the present invention;

FIG. 10 is a FRONT LEFT CORNER view and perspective view of the air jack connected to the spring air hose depicting the inflated state of it, according to a preferred embodiment of the present invention;

FIG. 11 is a REAR LEFT CORNER view of a “lifted” vehicle by the AIR JACK X in its inflated state and perspective view of the air jack connected to the spring air hose depicting the inflated state of it, according to a preferred embodiment of the present invention;

### DETAILED DESCRIPTION OF THE PREFERRED EMBODIMENT

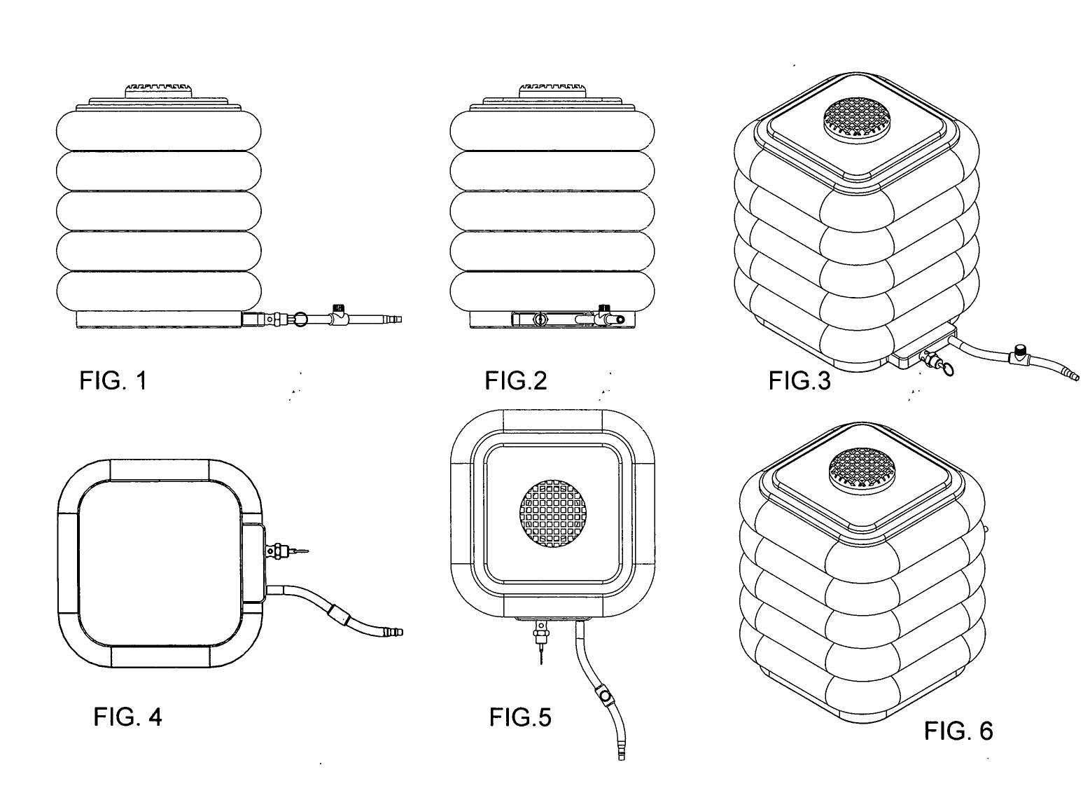

In accordance with the invention, the best mode is presented in terms of a preferred embodiment, herein depicted within FIGS. 1 through 4. However, the disclosure is not limited to a single described embodiment. A person skilled in the art will appreciate that many other embodiments are possible without deviating from the basic concept of the disclosure. Any such work around will also fall under its scope. It is envisioned that other styles and configurations can be easily incorporated into the present disclosure, and only one particular configuration may be shown and described for purposes of clarity and disclosure and not by way of limitation of scope.

The terms “a” and “an” herein do not denote a limitation of quantity, but rather denote the presence of at least one of the referenced items.

Referring now to FIG. 1, an environmental view of an air jack, according to a preferred embodiment of the present invention, is disclosed. The air jack comprises of base plate, a top plate, a rubber bag, a rubber surface mounted on top plate for better grip, drain valve and cap with air inlet connection and a pressure releasing valve. The base and top plate portions comprise of solid plastic which add stability and durability to the jack. It also provides containment of said rubber bag in between uses. Said base and lid plates comprise of a strong construction capable of supporting a weight associated with lifting a vehicle to change a tire or make various repairs. Said top plate is mounted with rubberized surface for grip between the vehicle base and the air jack, creating an anti-slip surface.

The rubber bag comprises of heavy-duty inflatable pressure vessel affixed to and positioned between said base and top plate portions. Once the air jack is positioned under the vehicle, a volume of compressed air is supplied by the air tank and/or air compressor to inflate the rubber bag via air hose utilizing the air inlet connection, thereby lifting said vehicle. Power is provided to the compressor via the car battery and air is stored in air tank for continuous use.

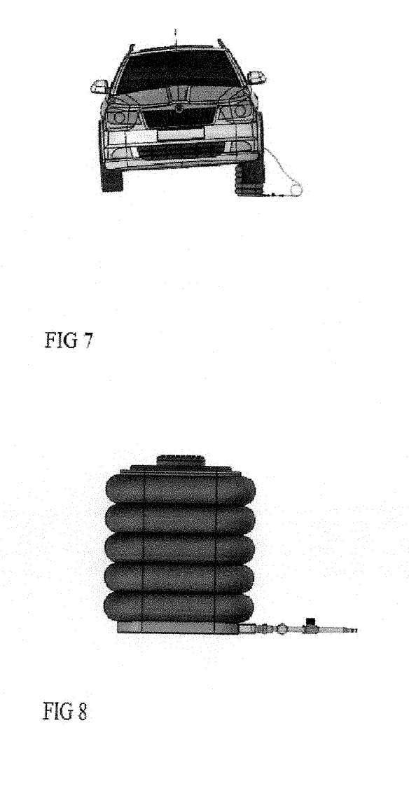

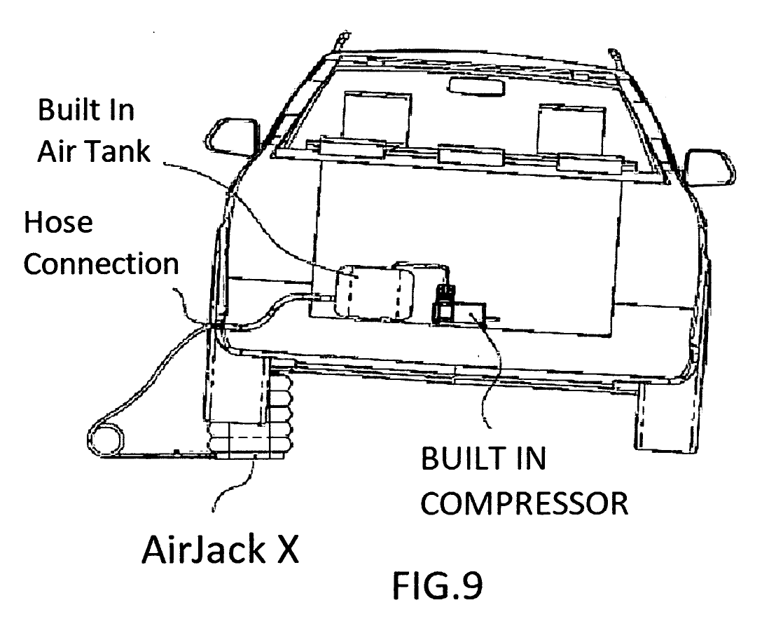

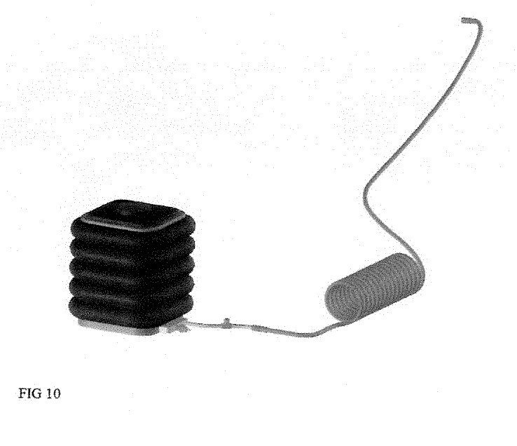

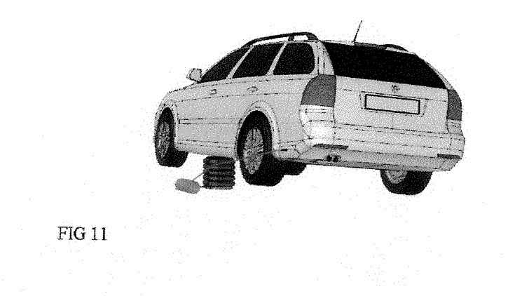

Referring now to FIGS. 3 and 6, perspective, side and top views of the air jack depicting collapsed and inflated states, according to the preferred embodiment of the present invention, are disclosed. The air jack comprises a plurality of plates, Rubberized surface mounted on top plate, a pressure relief valve, and an outlet and inlet connection. When the rubber bag is deflated, the air jack provides a compact form.

The top plate of the air jack comprises a raised surface that has flat rubberized surface to create and anti-slip connection to the car and the air jack during jacking. Said rubberized surface comprises an adhesively bonded rubber sheet material which provides a high-friction interface upon contact with a bottom surface of the vehicle. Furthermore, the air jack is envisioned to comprise of a solid plastic base plate for physical support.

In use, a user places the air jack beneath a vehicle, usually adjacent to a tire portion, and presses the power switch provided on dashboard to an “ON” position, thus inflating the rubber bag and causing a corner portion of the vehicle to be lifted. The vehicle is now in a position to change a flat tire or perform similar tasks. It is understood that various switch types may be utilized such as button switches, sliding switches, tilt sensing sensors and the like, with equal benefit. Inflation of the rubber bag is accomplished by plumbing a volume of compressed air produced by the air compressor and/or stored in air tank into said bladder via an air inlet connection. The compressor and air tank is protectively housed within the car where they are permanently attached as per requirement and space available. Said air compressor provides a means to pressurize ambient air into the connected tank and then through air hose connection via air hose, which is in turn delivered into the rubber bag, thereby causing said rubber bag to inflate and increase the height according to the manufacturers' specifications. This will differ for each car manufacturer. This being sufficient to lift a tire portion of the vehicle off a ground or paved surface. The air jack can be used for mechanical repairs, changing tires, getting vehicles out of snow and mud by using its built-in compressor and tank for mechanical repairs via pneumatic impact gun. The air tank is very useful when car is on low battery and in such conditions compressor cannot be operated. In such condition, air inlet valve will be opened and air from air tank will flow in to rubber bag and inflate it as per pressure gradient. Following inflation of the rubber bag and servicing of the vehicle, said rubber bag may be deflated quickly and easily via a pressure relief valve located along a front surface of the Base plate. Said pressure relief valve is in pneumatic communication with said rubber bag and preferably comprises a common digit-operated “poppet” valve or equivalent air regulating device. Upon complete deflation of the rubber bag, the air jack will return into its compressed transportable state.

The air compressor is envisioned to receive power from an existing electrical system of the vehicle via a power adapter and corresponding cord. Said cord is to be of sufficient length so as to extend from the air compressor while positioned in the car, to a ON/OFF switch located on the dashboard portion of said vehicle.

Referring now to FIG. 8, a section and perspective view of the air compressor and air jack, according to a preferred embodiment of the present invention, is disclosed. The rubber bag comprises a heavy-duty inflatable rubber pressure vessel affixed to the base and top plate portions preferably using industrial adhesives. The rubber bag further comprises of an integral air discharge valve and pressure release valve. Said discharge valve provides pneumatic communication with the rubber bag to deflate it. The air inlet provides pneumatic communication with the air compressor to inflate the rubber bag via spring coiled air hose. The air compressor is preferably a miniature diaphragm-type 12-volt DC unit which internally plumbs supply output air to the air tank which ultimately supplies air via air hose to rubber bag. The base plate provides an attachment means to an air hose along a bottom inner surface. The recoil mechanism is envisioned to be of a coil-spring-type and provides a compact means to store a length of air hose between the air inlet valve of rubber bag and the air compressor/air tank. The recoil mechanism is envisioned to provide a slight tension upon said air hose while said air hose is extended from air inlet valve of rubber bag to in-built air hose connection of the vehicle. After normal use of the air jack the air hose is detached from both ends and the recoil mechanism subsequently winds up and stores the air hose.

Referring now to FIG. 9, a section, top and perspective diagram of the air compressor and air tank in the car, according to a preferred embodiment of the present invention, is disclosed. The air compressor comprises a simple 12-volt DC circuit comprising the power adapter, the cord, a switch available on dashboard, and the motor portion of the air compressor. Power from the battery of the vehicle is conducted to the air compressor via switch. A common “ON-OFF” switch controls a flow of current to the motor portion of the air compressor to initiate inflation of the rubber bag of the air jack.

It is envisioned that other styles and configurations of the present invention can be easily incorporated into the teachings of the present invention, and only one particular configuration shall be shown and described for purposes of clarity and disclosure and not by way of limitation of scope.

The preferred embodiment of the present invention can be utilized by the common user in a simple and effortless manner with little or no training. The unit can be preinstalled by the vehicle manufacturer at the time of building the car. After initial purchase or acquisition of the complete system, it would be installed as indicated in FIG. 9.

The method of utilizing the air jack may be achieved by performing the following steps: procuring the air jack; installing the air compressor and air tank in the vehicle; storing the air jack in a trunk portion of a vehicle perhaps inside the spare tire until needed to perform tasks requiring jacking of a vehicle such as changing a flat tire, inspecting a vehicle undercarriage, or the like; removing the air jack from a trunk portion of the vehicle when needed; placing the air jack under a corner or side portion of the vehicle such as under the portion of chassis, or the like; manually connecting the air hose from built-in air hose connection to inlet valve of air jack outwardly a sufficient length; initiating the air compressor to inflate the rubber bag by pressing the switch to an “ON” position; in case of low battery power, just opening air inlet valve on air jack will let air from air tank move to rubber bag; allowing a period of time for the rubber bag to fill with compressed air and lift the vehicle to a desired height; pressing the switch to an “OFF” position, thereby ceasing lifting of the vehicle; performing needed tasks while the vehicle is jacked off the ground surface; and, benefiting from reduced effort and increased safety afforded to the user of the present invention.

The method of lowering and removing the air jack from the vehicle may be achieved by performing the following steps: lowering the vehicle by opening the drain valve to allow the compressed air to escape from the rubber bag until said rubber bag deflates completely flat and the vehicle is lowered to the ground surface; detaching the air hose from air inlet valve on air jack and built-in air hose connection on car; allowing the recoil mechanism to wind and contain the air hose; storing the air hose; and, storing the air jack in a trunk portion of the vehicle until needed again.

The foregoing descriptions of specific embodiments have been presented for purposes of illustration and description. They are not intended to be exhaustive or to limit to the precise forms disclosed and many modifications and variations are possible in light of the above teachings. The embodiments were chosen and described in order to best explain principles and practical application to enable others skilled in the art to best utilize the various embodiments with various modifications as are suited to the particular use contemplated.

1. the objective of the present invention is to provide simple actuation of the air jack (bladder) using a power switch available on the vehicle's dashboard that automatically inflates the bladder, resulting in elevation of a vehicle. This would mean that the operator of the vehicle can quickly place the air jack under the vehicle and from the safety of the vehicle operate its inflation without having to be concerned about getting hit by moving cars.

2. Another objective of the present invention is to provide built-in air compressor and air tank fitted in the vehicle which can be operated by a switch provided somewhere accessible, perhaps on but not limited to the dashboard.
The air-compressor is used to compress the air, while air tank is provided to store the compressed air in it.
The inflatable jack (AirJackX) consists of an air jack (Bladder), extension hose, built-in car compressor and an air tank. Accessories such as an air gauge for inflation of tires and a pneumatic Impact gun for removal of wheel nuts can also be combined and used with this system.

3. The air jack consists of two parts, flexible rubber bag, base and top plates which are made out of very strong solid plastic to keep the jack intact and free from getting damaged.
This structure would also mean that the jack is extremely light to carry.
The air compressor and air tank are attached to the car and it draws power from the car battery itself.
Example of Operation:
Upon getting a flat tire on a busy road or highway, we typically pull to the shoulder in order to change the tire. Currently the only way to do this is to call a mobile mechanic/tow truck or attempt to replace the tire yourself with an on board spare.
Currently the device available to do this elevation of vehicle is a mechanical jack. It is heavy and its operation is exhausting. The jack requires an exact placement in a very specific location under the car which can easily be missed in the dark. In order to find this location, the operator is required to lay down on the floor to have the underside of the car in his/her eye sight. Once this is done, the operator then has to manually operate the mechanical jack which takes a few minutes before it can elevate the vehicle.
During this time period the operator is in the unprotected path of oncoming vehicles and the danger of getting hit by a vehicle is of concern.
Once you elevate the vehicle with the current mechanical jack, you are then required to remove the wheel lug nuts, which due to the fact that most mechanics now days use high pressure pneumatic impact guns, the nuts are extremely difficult to remove. Due the amount of time the operator has to spend trying to undo these wheel lug nuts he/she is now in even more of a danger from getting struck by an upcoming vehicle.
Solution . . . AirJackX
AirJackX allows the operator to remove the light weight jack stored in the car and place it almost anywhere under a vehicle, connect the supplied air hose to the jack and to the air hose outlet connection of the car. Sit back inside the vehicle and by pressing the switch located inside the car elevate the vehicle until the flat wheel is off the ground. The operator is then notified by visual signal and or sound that the flat tire/wheel is ready to be replaced.
The operator can then use the supplied impact air gun and connect it to the same air hose and easily in a very effortless short time remove all wheel lug nuts.
Flat tire gets replaced, operator installs the lug nuts back and now disconnects the air hose from the car.
Finally the operator opens the AirJackX air drain valve and deflates the bladder, the weight of the vehicle and gravity allows this to be done rapidly. Operator places the AirJackX back in the trunk of the vehicle and he/she is safely on his way.
Claims are not limited to:
The AirJackX is not limited to just changing tires.
1) It can also be used for mechanical work to the car where elevation of the vehicle is required.
2) It can also be used for assisting a vehicle stuck in snow or mud.
3) Its use is not limited to just the car it's installed in. By using the supplied flexible air hose it can also be used to do all of the above to another vehicle as long as the vehicle is within reach.
4) The AirJackX is also not just limited to elevating/lifting of a vehicle. The operator can also use the sensor bypass switch and use the jack to elevate heavy items etc.
